(19) United States
(12) Patent Application Publication
(10) Pub. No.: US 2025/0238716 A1
(43) Pub. Date: Jul. 24, 2025

(54) SINGULARLY ADAPTIVE DIGITAL CONTENT GENERATION

(71) Applicant: INTUIT INC., Mountain View, CA (US)

(72) Inventors: Eyal COHEN, Tel Aviiv (IL); Yaakov TAYEB, Tzur Hadassa (IL)

(21) Appl. No.: 18/421,688

(22) Filed: Jan. 24, 2024

(51) Int. Cl. G06N 20/00

(52) U.S. Cl. CPC G06N 20/00

(57) ABSTRACT

Certain aspects of the present disclosure provide techniques for delivering singularly adaptive digital content that includes content components which are adapted in real time based on user interest metrics and using a generative model. Multi-layered content is generated, such that the content may be divided into content components which may each be adapted to be of a selected content type for a content class. The content components include one or more classes having one or more types. To adapt the content, subsequent content components may be adapted by changing which layer of the content component is selected or presented. The content component layers may have been previously generated using a generative model by using a base content component and a selection of content types for content classes. Changing layers for content components may occur when an attention score for the content falls below a threshold to improve interest in the content. Additional metrics may be recorded while the adapted content components are presented to create a feedback loop further optimizing layer selection and increasing interest in the content.

### INTRODUCTION

Aspects of the present disclosure relate to digital content that is generated and delivered in a singular adaptive format, such as the generation of dynamic content that is delivered in one-shot to a recipient and which is self-adapting based on various metrics associated with the recipient and measured while the content is being presented.

### BACKGROUND

Digital content of various types of media is regularly accessed on a global scale by users of various computing devices. Examples of digital content include web content, email contents, images, sound, newsletters, text components, interactive elements, and any other digital media accessible via a computing device. However, in many cases, content contained in digital media is static for different users and is often presented to users that are not interested in the digital content. Digital content that is interesting or useful for one user may not be interesting or useful for another user. Thus, static content is unable to optimally address a wide audience. For example, a traditional web page will have the same content regardless of the user visiting the page. The content may be therefore be interesting or useful, or optimized, for one user but not for another user having different preferences.

As a result of this stasis of content, digital media is often presented in a form that is not interesting or useful to some users, and/or which is not optimally interesting or useful. Traditional techniques of content generation are time-consuming and typically require human intervention. Particularly where a potential audience is large and/or diverse, it may be difficult or impossible to produce multiple unique versions of content optimized for users of different types. Furthermore, traditional methods of delivering content do not adapt to different users to determine what type of content would be most useful or interesting to that user.

Thus, there exists a need in the field of digital content generation for techniques that result in content which is of greater interest or utility, which results in a greater click-through rate for users, and/or which adapts to individual users to increase interest, utility, or engagement. Additionally, there exists a need for techniques to determine what type of content is most useful, interesting, or engaging for a user, and for delivering content that can be adapted on a user-by-user basis according to the type of content that is most useful, interesting, or engaging for the user.

### BRIEF SUMMARY

Certain embodiments herein provide a computer-implemented method for generating singularly adaptive digital content. In various embodiments, methods disclosed herein comprise: determining a user interest parameter for a content component of content output by a user interface, the content component being of a content type for a content class; receiving an interest score for the content component from an interest model in response to providing the user interest parameter as input to the interest model; determine, based on the interest score and a threshold interest score, a different content type for the content class; and selecting a layer for a subsequent content component of the content having the different content type.

Embodiments disclosed herein also provide a method, comprising: receiving a corpus of text; generating a plurality of labeled text components from the corpus of text, the plurality of labeled text components including a label for a content type of a content class; generating training data using the labeled text component by recording an interest level and a read speed attribute for the labeled text component; and training a machine learning model, through a supervised learning process using the training data to output a present interest level for a present text component based on a present read speed attribute.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 illustrates an example computing environment in which singularly adaptive digital content may be generated and delivered to client device, according to various embodiments of the present disclosure.

FIG. 2 illustrates an example system architecture for generating singularly adaptive digital content, according to various embodiments of the present disclosure.

FIG. 3 illustrates an example workflow for delivering singularly adaptive digital content, according to various embodiments of the present disclosure.

FIG. 4 illustrates an example method for delivering singularly adaptive digital content, according to various embodiments of the present disclosure.

FIG. 5 illustrates an example system configured for singularly adaptive digital content generation and delivery, according to various embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Embodiments described herein involve generating adaptive digital content, making it possible to deliver content to a user or client device that adapts dynamically. The adaptive content is generated using content components and multiple layers for the content components. A content component may be a textual component such as a word, sentence, or paragraph, an image or portion of an image, an audio component, etc. The content can be delivered to a user via various platforms such as a website, application, email, etc., Metrics indicating how the user engages with the platform can be used to select or change a layer for a content component. The different layers for the content components are different versions of the same base content having different attributes, such as different types for different content classes. For texts, a content component can be a sentence, two sentences, or a cluster of related sentences. In this way, while a user is experiencing a particular content component, layers for subsequent content components can be adapted or selected based on the attention score or engagement of the user with respect to the particular content element.

To determine which layer to present to a user, an interest model is built for the user. An interest model for a user includes a set of parameters defined by arguments for the state of the platform, input/output operations, and/or interactions between the user and the platform. The parameters may be used to determine or rank one or more content types for which the user is expected to have increased engagement with the platform. In various embodiments, different interest models may be used to score or compare user engagement or interest in the platform and/or content component. Interest models can be based on user engagement with components of the platform, or based on screen position of content elements, scroll bar position, clickstream data, mouse movement data, and/or other factors.

To build the interest model, training data may be generated by performing labeling with user—coder pairs. For example, a user of a platform indicates a level of interest as the platform is used. The coder records the content component associated with the level of interest recorded. The content component may be of a type or a base type. Metrics associated with the use of the platform are recorded. Metrics affecting interest level are determined. Content components, such as component text and the associated interest score can be used as labels for a learning data set. Input features for the learning set can include a component identification number, a scrolling position, one or more class types (such as a tone type or audience type), a speed (such as a scroll speed or mouse speed), time duration, content length, average read speed, or other features. These or other various metrics affecting interest level may be used as training data for machine learning to build a model for inferring an interest for a content component based on the metrics based on the labeled learning set.

As a user continues to engage with the platform, additional metrics may be recorded while subsequent content components are presented via the platform. These additional recorded metrics may be used as additional training data, such that feedback is provided to the model based on the initial metrics and metrics recorded during presentation of various content components on the platform.

In this way, it may be determined when an interest level has fallen below a threshold interest level for a platform using the model. In such cases, subsequent content may be presented that is of a different type that the user has not experienced or for which it has been inferred the user is more likely to be interested.

Techniques described herein provide various technical improvements with respect to conventional techniques for generating and providing content in software applications. For example, by using content components that have multiple layers, techniques described herein allow a single digital content item to be dynamically adapted for different users and different contexts in an efficient manner, thereby overcoming the technical limitations of static digital content. Additionally, by automatically determining user interest through the use of an interest model as described herein on an ongoing basis as a user consumes content and/or otherwise interacts with a software application, embodiments of the present disclosure allow content to be dynamically adapted based on accurately determined user interest, such as in real-time and/or as factors change. Furthermore, by training a machine learning model to predict interest level based on various metrics and re-training the machine learning model over time based on user feedback, techniques described herein provide an interactive feedback loop by which an interest prediction model and associated content adapting system are iteratively improved over time. Embodiments of the present disclosure also reduce computing resource utilization by avoiding the computing resource utilization that would otherwise be associated with providing content that is irrelevant or not optimized for a particular user and/or context.

### Example Computing Environment for Singularly Adaptive Digital Content

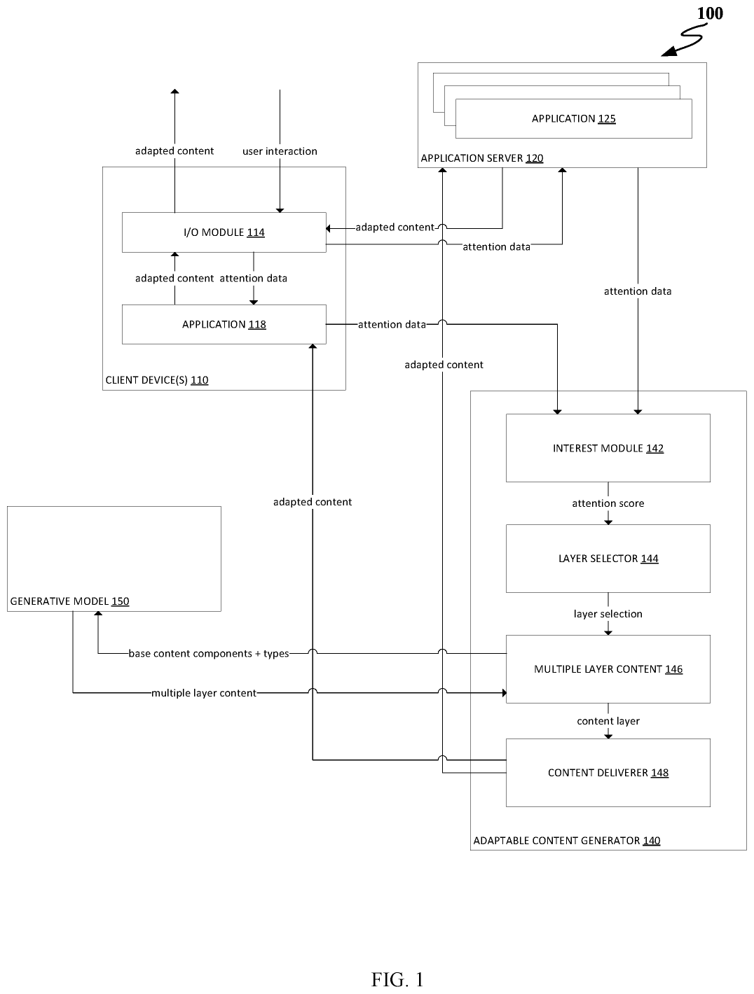

FIG. 1 illustrates an example computing environment 100 in which singularly adaptive digital content can be generated and delivered to a client device. In FIG. 1, one or more client devices 110 are connected to an application server 120 to access one or more applications 125. In the example, a client device 110 may be any type of computing device, such as a laptop or smart phone, which may be used to execute an application or access network resources. In various embodiments, client data (including user input, clickstream data, and/or other client or user data) from the client device 110 is received by the application server 125 via an I/O module 114 of the client device 110. The application 125 can be used to provide or output adaptable content 140. In various embodiments, the adaptable content may be a part of an email or newsletter that is accessed by a web browser or email application. In other embodiments, the adaptable content may be a textual component or image located on a web page. In situations, content may adapt in a read direction or scroll direction of the email, newsletter, or web content element.

In some embodiments, one or more applications 118 may run locally on the client device. However, the client device 110 may also be used to access an application server 120 hosting an application 125 remotely. The applications 118, 125, may be used to deliver the content to the client device 110, such as via the I/O module 114. Various inputs and outputs can include audio/visual displays or recorders, as well as mouse, keyboard, gesture-based, or other types of input or output. In various embodiments, client device 110 and/or the I/O module 114 may include a network module for communication via networked connection with the application server 120.

In FIG. 1, the applications 118, 125 include modules for detecting and recording interest data. Various metrics can be recorded by the applications 118, 125 that are related to a user's interest level in content being presented via the applications 118, 125. For example, in the case of text being presented to a user via an application, metrics may be recorded indicating a scroll bar position, scroll speed, mouse location, mouse movement, etc. Other attention metrics might include gaze direction, proximity to an object (such as an augmented reality/virtual reality (AR/VR) object or a speaker), etc.

In the example of FIG. 1, attention data is provided to an interest module 142 of the adaptable content deliverer 140. In various embodiments, the applications 118, 125 may be used to access, display, or otherwise output the adaptable content 140 and record attention data metrics while the adaptable content 140 is output. In various embodiments, the adaptable content generator 140 may be included in an application 118, 125, or may be used to provided adaptable content to the application (such as an adaptable newsletter or web page).

The interest module 142 applies an interest formula to determine attention scores for content output from the client device 110. The attention score may be provided to the layer selector 144. Based on the score, the layer selector 144 may adapt a subsequent content component for content output from the client device 110. For example, a low attention score may result from a rapid scroll speed indicating a low level of interest for a content component. The layer selector may receive the low attention score and adapt subsequent content components of the content to present a layer of different type than the content component for which a low level of interest was indicated. Thus, if a user is scrolling quickly through content, or has otherwise moved or navigated away from a content component, a low attention score will result and subsequent content components of a different type will be presented by changing which layer of the content is presented.

In various embodiments, the content includes multiple components with multiple layers. The layers may have been previously generated using a large language model and a selection of one or more types for one or more content classes. Any number of content types and classes may be used. By way of example, a first content class has two types, a second content class has three types and a third content class has four types. Thus, a language model in this example may be used to generate twenty-four layers for each content component. In another example, a first content class has five types and a second content class has five types. A model in this example may be used to generate twenty-five layers for each content component. In various embodiments, more or less classes and/or types may be selected. In practice, feedback is accumulated which allows identification and elimination of content type combinations which result in inadequate attention scores. Thus, an initially larger number of types may be narrowed by using feedback to eliminate type combinations falling below a threshold score until a suitable set of types is reached.

In the example of FIG. 1, the multiple layer content 146 is generated by providing base content components for content to the generative model 150. In the case of textual elements, a large language model may be used. In some cases, a generative image model may be used, such as by providing a base image and a plurality of image types (i.e. for tone, audience, style, etc.) as generative model 150. Thus, the multiple layer content 146 may have a layer for each component for each of the types provided to the model 150.

The layer selector 144 can determine a content type and make a content type selection from the multiple layer content 146 by selecting a layer of content to be provided to the content deliverer 148. In various embodiments, the content type may be selected from content types which have a highest likelihood of resulting in increased interest. The content type may also be selected from content types which have not been previously selected. The content type may be selected based on an attention score falling below a threshold. In some cases, subsequent content components of a different type are not selected unless an attention score for a current content component falls below a threshold, such as 50% of a maximum score, or 85% of a maximum score, or a higher or lower threshold, such that high-attention content is not adapted but low-attention content is adapted.

In various embodiments, layers of content components can have various classes each with various types. For example, a tone class can have a serious type, a humorous type, a sarcastic type, etc. As another example, a target audience class can have a young age group type, a middle aged group type, and an old age group type. A target audience class may also have a beginner type, an intermediate type, and an expert type. In general, any combination of classes and types that is understandable by a generative model may be used as a context along with a base content component to generate an adapted subsequent content component. The content adapter 144 provides the base content, or a base content component, to the generative model 150. The content adapter also provides a content type as context to the generative model 150. Any number of content classes and/or types may be used in various embodiments. For example, a content component may have a “formal” type for a “tone” class, a “short” type for a “length” class, and/or an “intellectual” type for an “audience” class.

In general, different types of generative models may be used to generate adapted content based on the base content and the provided context. The generative model 150 may, for example, be a large language model that generates a content component based on a base content and one or more types as context.

The content deliverer 146 receives the selected content layer for one or more subsequent content components from the multiple layer content 146 and provides the content components of the selected layer to the content deliverer 148. The content deliverer 146 receives the adapted content components and delivers the content components to one or more applications 118, 125. In various embodiments, the content deliverer can format or preprocess the content components before delivery to an application 118, 125. An application programming interface (“API”) may facilitate communication between the content generator and applications 118, 125.

In some cases, adapting content may include changing all subsequent content components to a layer of the selected type. In some cases, the subsequent content components may present the layer of a type as long as an attention score threshold is maintained. For example, if the attention score drops below an attention score threshold, the subsequent content may change to a new layer selection. In embodiments, one or more actions can be taken in response to one or more attention score thresholds. Depending on the attention score, subsequent content component may revert to a base content component, a content component of a default type, or a content component algorithmically selected based on attention score history for content components for an account, user, or session.

In some embodiments, attention data may be collected subsequent to delivery of adapted content by the content deliverer 148. In such cases, the subsequent attention data may be received by the interest module 142 and a subsequent attention score may be determined and provided to layer selector 144. Layer selector 144 may then select a different subsequent content type. In this way, a loop in generated in which different types of content are delivered and feedback is received for the different types of content. Content types for which higher attention scores result can be selected more frequently, resulting in a feedback loop which increases the likelihood of attention data indicating a relatively higher degree of user interest. This enables subsequent content components to be algorithmically selected based on attention score history for past content components for an account, user, or session, improving the overall effectiveness at maximizing interest. Various techniques may be applied to make a selection based on feedback and/or remaining unselected types.

### Example Architecture for Singularly Adaptive Digital Content

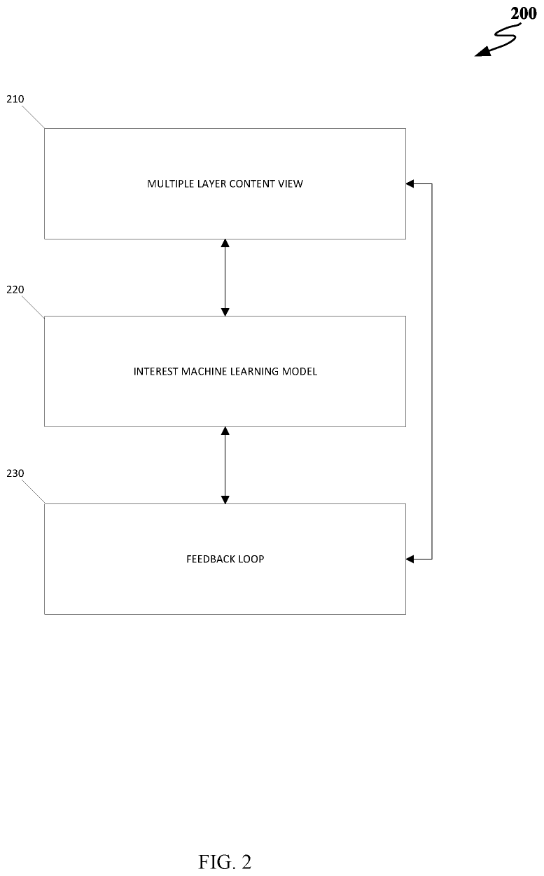

FIG. 2 illustrates an example architecture 200 for generating singularly adaptive digital content, according to various embodiments of the present disclosure. In FIG. 2, the architecture 200 includes a multiple layer content view layer 210. An interest machine learning model 220, and a feedback loop 230.

The multiple layer content view layer 210 may act as a frame that contains many layers of the same content, with only one layer appearing at a time. In the case of textual content, the size of the view may be related to a read speed, such as by being a few sentences or a paragraph.

In one example, if the content is about a first subject, the content will include multiple layers about the first subject that are written in different ways using a different type for a content class. These ways deviate from one another by the text tone, size, function, demographic and/or other content classes. Although the number of combinations of content types for content classes may be very large such that traditional approaches would not be able to easily produce content for all possible combinations, the present invention solves this problem by using a generative large language model to generate content about the subject using a selection of any content types as context. At a given time, one layer for each content component is presented. When an attention score for the user drops below a threshold, subsequent content components may be adapted by the changing to a different layer.

To determine when the content type of content components should be adapted, an interest model may be used. In some embodiments, the interest model is trained using supervised machine learning. Supervised machine learning may be performed by generated seed text articles as training data using a selection of content types. For example, articles may be generated with multiple types of tones (formal, friendly, informative, playful, et al.,) and with multiple types of audiences (parents, singles, young adults, intellectuals, etc.). A reader reads the seed articles using a platform that records interest metrics while a recorder records the content component being consumed and the level of interest during the consumption for that component.

The architecture 200 also includes an interest model layer 220. At the interest model layer 220, an interest model is used which has been built using machine learning. In various embodiment, the interest model may be trained or fine-tuned using machine learning or may be a pre-trained machine learning model. Various interest measures can be recorded as interest metrics. For example, user engagement with a computing device displaying content may be recorded, such as metrics indicating a scroll bar position, scroll speed, mouse location, mouse movement, etc. Other attention metrics might include audio, video, or other input used to determine gaze direction, proximity to an object (such as an AR/VR object or a speaker), user movement, etc., which may be recorded and used as an interest metric for computing an attention score.

To generate training data, each text component is provided with its types for each content class, with a recorded level of interest and reading speed. In some cases, a change or delta in read speed is used rather than an absolute read speed, to account for individual differences in read speed. Using this training data, various machine learning techniques can be applied to build an interest model. Such techniques include Random Forest models, feed forward fully connected neural networks, or any other machine learning model. The interest model may be trained and validated using test dataset splits, and may be trained using training data for which outliers have been removed and/or noisy data has been cleaned. The interest model may be hosted at a server and accessible to client devices or other devices or applications.

In some embodiments, training of a machine learning model such as the interest model is a supervised learning process that involves providing training inputs (e.g., metrics) as inputs to a machine learning model. The machine learning model processes the training inputs and outputs predictions (e.g., predicted interest scores) based on the training inputs. The predictions are compared to the known labels associated with the training inputs (e.g., labels based on ground truth or manual labeling indicating whether a user was actually interested in content) to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art.

Various recommendation systems use ways to predict if a user enjoys specific content. An implicit way assumes the item that a user consumed was “enjoyable.” An explicit way receives a user ranking of the item. In one example, a model is built that uses a size of a content component, a time the component appears on the page, and a speed at which a user scrolls the page to predict the users' level of interest. When the interest is high no change is needed, otherwise, the presented layer of the multiple layer content view may be changed to find a better way to engage with the user. Additional interest metrics may then be gathered while the adapted content is presented. In various embodiments, previous content components may or may not be adapted.

The architecture 200 also includes a feedback loop layer 230. At the feedback loop layer 230, a feedback loop refines the adaptation of the digital content. In various embodiments, the feedback loop can be an initialized and/or a refined loop. In various examples, data can be collected from client devices, or application servers while the adaptive content is being displayed or otherwise output by an application. If a computed attention score becomes to low, the upper layer is changed in the immediately subsequent parts of the text. The prediction and adaptation happens continuously until computed interest scores are above a threshold. Attention metrics are continuously received by the feedback loop to facilitate a better starting point for the next iteration.

In some embodiments, interest metrics and content component data is sent online to a cloud storage location. This data enables the interest model to be retrained using the recorded data. The information may be recorded includes, but is not limited to subjects of content components, content components' content types, speed of reading for an instance of a content component, average speed for all instances of a content component; time of the day, demographic information, or other information.

In addition to improving the resulting attention, collecting this information and using this information as feedback enables elimination of not relevant types from the selection of content types. For example, for certain texts (e.g., humoristic tone for sad news) certain type combinations need not be selected. By eliminating these selections, the number of changes needed before getting reaching an attention score threshold can be reduced. Thus, the feedback may result in optimizations such as increased user attention to content, less time to reach an attention score threshold, and more time spent above an attention score threshold, and the feedback results in less resources being required to achieve increased user interest or attention.

### Example Workflow for Delivering Singularly Adaptive Digital Content

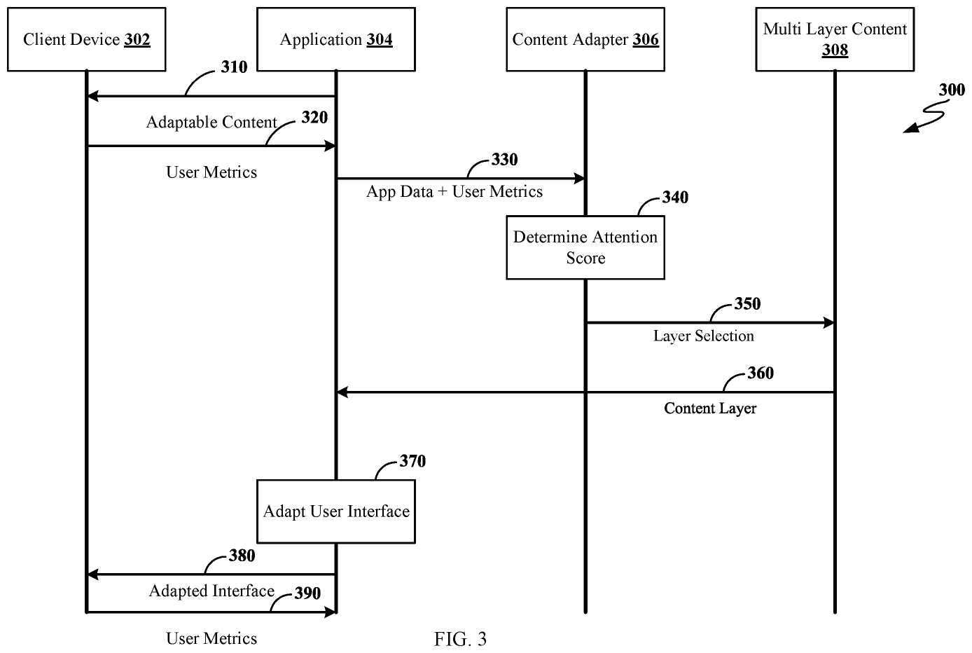

FIG. 3 illustrates an example workflow 300 for delivering singularly adaptive digital content, such as for delivering content to a client device, according to various embodiments. In FIG. 3, a client device 302 is used to operate an application 304. The application 304 is in communication with a content adapter 306. The content adapter is in communication with a large language model 308.

As shown, the workflow 300 begins at stage 310 where the application 304 delivers adaptable content to the client device 302. While components of the adaptable content are output at the client device 302, various user interest or attention metrics are measured and recorded.

The workflow 300 then proceeds to stage 320 where the user metrics are provided to the application 304. For example, mouse and/or click bar position, scroll rate, or other user actions may be recorded. The application 304 receives the user metrics and correlates the user metrics to the content components and types being output by the client device. The application 304 may also record other information or data associated with the user or other metadata, such as user demographics or engagement history with the application 304. At stage 330, the application data, metadata, and user metrics are sent by the application 304 to the content adapter 306.

At stage 340, the content adapter 306 determines an attention score for a content component based on the application data, metadata, and/or user metrics received from the application 304. If the attention score is below a threshold score, such as below 50% of a maximum attention score, or such as being within one or more standard deviations from a minimum or maximum attention score, the content adapter may select a different content type for a content class associated with the content component for which the attention score was determined. In other words, if the attention score for a content component of a first type indicates that a user is not interested in the content component of the first type, the content adapter can select a different type for a subsequent content component.

At stage 350, the content adapter 306 may make a layer selection for the subsequent content component from the multiple layer content 308. The layer selection may correspond to a type for a class provided as context with a base content component to a large language model. Using the base content component as input and the types as a context, the large language model 308 generates the layers for the multiple layered content 308. The corresponding layer of subsequent content components is then provided to the application 304. In various embodiments, the content component may be transmitted to an application, client device, application server, or other endpoint. Various examples of content components and applications include: a generated web page content component, including text, image, or sound, output by a client device via a web browser application; A sentence or combination of sentences in an email or newsletter displayed on a client device via an email service, application, or applet; or any other content component of an output or user interface of an application. In a particular embodiment, a content component length for a text-based component may be a number of sentences selected based on a read speed of the user or other metric.

In FIG. 3, the selected content layer of the multiple layer content 308 is received by the application 304 at stage 360. In some cases the content component may be received by the content adapter 306. In the example of FIG. 3, the application receives the subsequent content component and inserts the content component into a user interface of the application. In particular, a scroll direction, text read direction, or workflow direction can be used to determine where a subsequent content component should switch to a different content component layer, such as determining a subsequent content component based on a read direction (left-to-right or right-to-left), a scroll direction, or navigation through pages of a web site. At stage 370, the application 304 adapts a user interface based on the content component layer. For example, a generated textual content component may be unformatted. The application 304 may format the textual component for consistency within the application. A subsequent textual component may be selected to introduce the different layer that is one or more components subsequent to a current component. For example, a change in a content component layer for a textual component may be selected that is a few sentences ahead, that is at or near the bottom of a display of a client device, or that is “below” the screen or on a portion of an interface of a page of a website not yet displayed by the display of the client device. Such a textual component may be a component of a web page, email, newsletter, eBook, etc.

Next, the adapted interface is transmitted to the client device at stage 380. In various embodiments, as the client device 302 is used to access the application 304 with the adapted interface, subsequent user metrics are measured and recorded by the application. Such metrics can include any interactions between a user, the client device and/or the application. These subsequent metrics and additional application data may be provided to the content adapter 306 at stage 390 to generate further, additional subsequent adapted content. This iterative process enables a feedback loop in which the user metrics result in an attention score used to influence an adapted interface for which more user metrics are recorded either continuously improving attention or improving attention until or as long as a threshold is maintained (such that it may be the case that content is not adapted until the threshold is no longer maintained).

### Example Method for Delivering Singularly Adaptive Digital Content

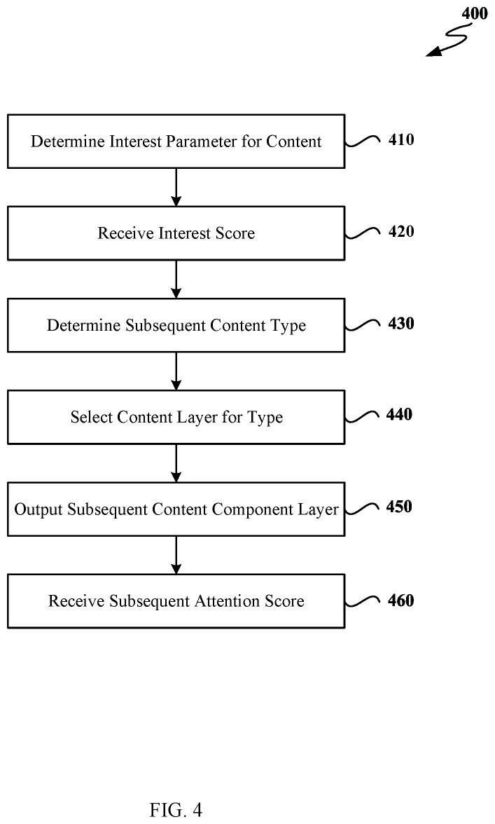

FIG. 4 illustrates an example method for delivering singularly adaptive digital content, according to various embodiments. In FIG. 4, the method 400 begins at stage 410 where an interest parameter for content is determined. For example, scroll bar position, scroll speed, mouse movement, etc. mouse and/or click bar position, scroll rate, read speed, gaze direction, proximity to an object, or other metrics may be recorded to determine values for interest parameters. One or more interest parameters can be selected based on one or more of these or other metrics.

Next, the method 400 may proceed to stage 420 where an interest score is received. In various embodiments, an interest score may be algorithmically determined by using user interest metrics to determine values for the interest parameters. Based on the available metrics, an attention score can be computed using a weighted sum or algorithm.

In some cases, a machine learning model used to output an attention score based on interest parameters as input. Such a machine learning model may have been trained via supervised learning using sets of interest parameters and values that are labeled with an attention score. The attention score label may be real number values or binary values.

Next, the method 400 continues at stage 430 where a subsequent content type is determined. In FIG. 4, content may include content components having content types for various content classes. If an interest score is not high enough and indicates inattention, a content type may be selected that is different from a current or base content type for the content component for which the low attention score was received. In various embodiments, a record of attention metrics for each presented content component is maintained. The data may include a content component type history for a user, account, or user session with attention metrics and attention scores associated with content components which may be of a type or types for one or more classes.

A subsequent content type in some embodiments may be determined by selecting a content type at random from previously unselected types. In other embodiments, the data including the content component type record and associated attention data is used to create an interest model for making predictions or inferences which are used to select a content type most likely to increase interest or attention. In further examples, a plurality of types for a plurality of content classes are selected for a subsequent content component based on an algorithmic selection weighted according to recorded attention data and with a selection process for unselected types.

The method 400 then proceeds to stage 440 where a content layer selected. In various embodiments, a large language model may have been used to generate multiple layers for each subsequent content component by providing a base content component and a selection of content component types to the large language model. The large language model generates texts that parallels the base content component but which exhibits different qualities based on the one or more different class types. The generated texts can be used as unique layers for content components of adaptive content. Which layer of subsequent content components is presented may be based on the selected content layer.

The method may then proceed to stage 450 where the layer of the subsequent content component is output. For example, the selected layer matching the determined content types for the subsequent content component can be output on a display of a client device and/or transmitted via a networked connection to a client device or application server. The subsequent content component may be processed by an application at the client device or application server, such as for consistency with a user interface.

The method 400 may then proceed to stage 460 where a subsequent interest score is determined. For example, while the subsequent content component is being output, attention metrics can be measured, recorded, and/or used to calculate or determine an attention score. The attention score may be used as a basis to determine whether to adapt additional subsequent content components. Over time, attention score data for additional subsequent content components can be recorded and used as feedback to continuously improve user interest. The feedback loop may continue indefinitely, or until an interest score threshold is reached for content components.

### Example System for Singularly Adaptive Digital Content Generation and Delivery

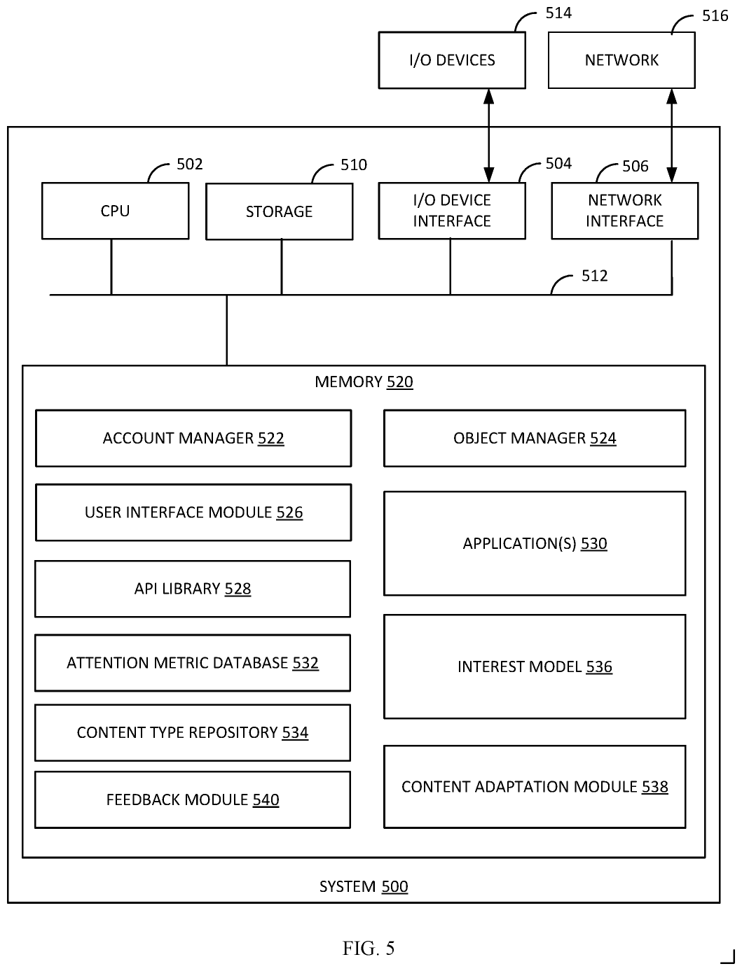

FIG. 5 illustrates an example system configured for singularly adaptive digital content generation and delivery, according to various embodiments of the present disclosure. As shown, system 500 includes a central processing unit (“CPU”) 502, one or more I/O device interfaces 504 that may allow for the connection of various input and/or output (“I/O”) devices 514 (e.g., keyboards, displays, mouse devices, pen input, etc.) to the system 500, network interface 506 through which system 500 is connected to network 516 (which may be a local network, an intranet, the internet, or any other group of computing devices communicatively connected to each other), a memory 520, storage 510, and an interconnect 512. In embodiments, the I/O devices 514 and/or network interface 506 may be used to receive input from a user device, such as navigation commands or any other user engagement which may indicate user interest or attention.

CPU 502 may retrieve and execute programming instructions stored in the memory 520 and/or storage 510. Similarly, the CPU 502 may retrieve and store application data residing in the memory 520 and/or storage 510. The interconnect 512 transmits programming instructions and application data, among the CPU 502, I/O device interface 504, network interface 506, memory 520, and/or storage 510. CPU 502 is included to be representative of a single CPU, multiple CPUs, a single CPU having multiple processing cores, and the like.

Memory 520 is representative of a volatile memory, such as a random access memory, or a nonvolatile memory, such as nonvolatile random access memory, phase change random access memory, or the like. As shown, memory 520 includes an account manager 522, an object manager 524, a user interface module 526, an API library 528, one or more applications 530, an attention metric database 532, a content type repository 534, an interest model 536, a content adaptation module 538, and a feedback module 540.

In various embodiments, the account manager 522 sends, receives, stores, changes, or otherwise manages account information, which may be associated with particular user. The account manager be suitable for executing operations related to account creation and for managing access, privileges, and/or rights associated with accounts, including payment, ownership, or renting of products or other objects.

In embodiments, the object manager 524 sends, receives, stores, changes, or otherwise manages object information, which may be associated with particular data objects used by the system. Data objects may be associated with one or more accounts and include tokens, licenses, products, other data objects that may be owned by or otherwise associated with an account and/or other data objects used by the system.

In the example, the user interface module 526 facilitates a user or administrator using or accessing the system via one or more user interfaces, such as to update or manage the system, or perform operations on or with the system, etc. The API library 528 may contain information which facilitates the system interfacing with various applications, such as various applications accessed by a client device via an application server.

In various embodiments, one or more applications 530 may be executed by a user to receive the adaptive content as output from the one or more applications 530. While a user is engaging with an application 530, attention metrics measuring user interest may be measured and recorded in an attention metric database 532 which stores attention metrics and/or associated content components. The content type repository 534 may include a library of possible content classes and possible content types for each content class. The content type repository 534 may further include an indication that certain content type combinations should not be used or selected for certain content subjects.

In the example, the interest model 536 is a trained model that provides an attention score based on values for interest parameters input into the interest model. The content adaptation module 538 receives attention scores from the interest model 536 and adapts content components of a piece of adaptable content by changing which layer of a content component is presented. In various embodiments, the content adaptation module 538 may select a content layer type based on unselected content types, based on a type for which it has been inferred a high interest score may result, and/or based on an algorithmic selection process. In this case, layers of the multi-layered content view may have been previously generated by a language model, and the attention model may be used to determine which layer of the content is presented or provided.

In FIG. 5, the feedback module 540 receives attention metric data about adapted content components. The attention metric data may be used to train, retrain, or fine-tine the interest model to better infer interest levels based on input values for interest parameters. The better inferences result in improved attention scores which enable faster detection of content types for low user interest and more accurate determinations of when interest is sufficiently high that content should not be adapted. In this way, the metrics are continuously used as feedback to optimize and further improve the system.

### Example Clauses

Aspect 1: A method for generating content for user interfaces comprising: determining a user interest parameter for a content component of content output by a user interface, the content component being of a content type for a content class; receiving an interest score for the content component from an interest model in response to providing the user interest parameter as input to the interest model; determine, based on the interest score and a threshold interest score, a different content type for the content class; and selecting a layer for a subsequent content component of the content having the different content type.

Aspect 2: The method of Aspect 1, wherein the interest model comprises a machine learning model trained to generate an interest score for a content component of a user interface based on user interest parameters.

Aspect 3: The method of any of Aspects 1-2, wherein the user interest parameter comprises a scroll rate, a click bar position, or a reading speed.

Aspect 4: The method of any of Aspects 1-3, wherein the content comprises a plurality of content components having a plurality of layers generated by a generative model, the plurality of layers corresponding to content types provided to the generative model.

Aspect 5: The method of any of Aspects 1-4, wherein the content class comprises audience, tone, purpose, size, function, or demographic.

Aspect 6: The method of any of Aspects 1-5, further comprising determining a subsequent interest score for the subsequent content component; selecting, based on the subsequent interest score, a next subsequent content type; and selecting a subsequent layer for a subsequent content component having the next subsequent content type.

Aspect 7: The method of any of Aspects 1-6, wherein the content component is generated by providing a base content component and a default type to a generative model.

Aspect 8: The method of any of Aspects 1-7, further comprising determining a user type associated with the user interface; and generating the content component using a generative model by providing to the generative model a base content component and an initial content type defined by the user type.

Aspect 9: A system for generating content for user interfaces, comprising: a memory having executable instructions stored thereon; one or more processors configured to execute the executable instructions to cause the system to perform a method, the method comprising: determining a user interest parameter for a content component of content output by a user interface, the content component being of a content type for a content class; receiving an interest score for the content component from an interest model in response to providing the user interest parameter as input to the interest model; determine, based on the interest score and a threshold interest score, a different content type for the content class; and selecting a layer for a subsequent content component of the content having the different content type.

Aspect 10: The system of Aspect 9, wherein the interest model comprises an inference model trained to generate an interest score for a content component of a user interface based on user interest parameters.

Aspect 11: The system of any of Aspects 9-10, wherein the user interest parameter comprises a scroll rate, a click bar position, or a reading speed.

Aspect 12: The system of any of Aspects 9-11, wherein the content comprises a plurality of content components having a plurality of layers generated by a generative model, the plurality of layers corresponding to content types provided to the generative model.

Aspect 13: The system of any of Aspects 9-12, wherein the content class comprises audience, tone, purpose, size, function, or demographic.

Aspect 14: The system of any of Aspects 9-13, determining a subsequent interest score for the subsequent content component; selecting, based on the subsequent interest score, a next subsequent content type; and selecting a subsequent layer for a subsequent content component having the next subsequent content type.

Aspect 15: The system of any of Aspects 9-14, wherein the content component is generated by providing a base content component and a default type to a generative model.

Aspect 16: The system of any of Aspects 9-15, wherein the method comprises determining a user type associated with the user interface; and generating the content component using a generative model by providing to the generative model a base content component and an initial content type defined by the user type.

Aspect 17: A method of training a machine learning model, comprising: receiving a corpus of text; generating a plurality of labeled text components from the corpus of text, the plurality of labeled text components including a label for a content type of a content class; generating training data using the labeled text component by recording an interest level and a read speed attribute for the labeled text component; and training a machine learning model, through a supervised learning process using the training data to output a present interest level for a present text component based on a present read speed attribute.

Aspect 18: The method of Aspect 17, wherein the read speed attribute comprises a selection from a read speed; a read speed delta; a scroll rate, or a scroll position.

Aspect 19: The method of any of Aspects 17-18, further comprising processing the training data to remove outliers or to clean noise.

Aspect 20: The method of any of Aspects 17-19, wherein the present text component and the corpus of text use a common format.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for generating content for user interfaces comprising:
determining a user interest parameter for a content component of content output by a user interface, the content component being of a content type for a content class;
receiving an interest score for the content component from an interest model in response to providing the user interest parameter as input to the interest model;
determine, based on the interest score and a threshold interest score, a different content type for the content class; and
selecting a layer for a subsequent content component of the content having the different content type.

2. The method of claim 1, wherein the interest model comprises a machine learning model trained to generate an interest score for a content component of a user interface based on user interest parameters.

3. The method of claim 1, wherein the user interest parameter comprises a scroll rate, a click bar position, or a reading speed.

4. The method of claim 1, wherein the content comprises a plurality of content components having a plurality of layers generated by a generative model, the plurality of layers corresponding to content types provided to the generative model.

5. The method of claim 1, wherein the content class comprises audience, tone, purpose, size, function, or demographic.

6. The method of claim 1, further comprising:
determining a subsequent interest score for the subsequent content component;
selecting, based on the subsequent interest score, a next subsequent content type; and
selecting a subsequent layer for a subsequent content component having the next subsequent content type.

7. The method of claim 1, wherein the content component is generated by providing a base content component and a default type to a generative model.

8. The method of claim 1, further comprising:
determining a user type associated with the user interface; and
generating the content component using a generative model by providing to the generative model a base content component and an initial content type defined by the user type.

9. A system for generating content for user interfaces, comprising:
a memory having executable instructions stored thereon;
one or more processors configured to execute the executable instructions to cause the system to perform a method, the method comprising:
determining a user interest parameter for a content component of content output by a user interface, the content component being of a content type for a content class;
receiving an interest score for the content component from an interest model in response to providing the user interest parameter as input to the interest model;
determine, based on the interest score and a threshold interest score, a different content type for the content class; and
selecting a layer for a subsequent content component of the content having the different content type.

10. The system of claim 9, wherein the interest model comprises an inference model trained to generate an interest score for a content component of a user interface based on user interest parameters.

11. The system of claim 9, wherein the user interest parameter comprises a scroll rate, a click bar position, or a reading speed.

12. The system of claim 9, wherein the content comprises a plurality of content components having a plurality of layers generated by a generative model, the plurality of layers corresponding to content types provided to the generative model.

13. The system of claim 9, wherein the content class comprises audience, tone, purpose, size, function, or demographic.

14. The system of claim 9, wherein method further comprises:
determining a subsequent interest score for the subsequent content component;
selecting, based on the subsequent interest score, a next subsequent content type; and
selecting a subsequent layer for a subsequent content component having the next subsequent content type.

15. The system of claim 9, wherein the content component is generated by providing a base content component and a default type to a generative model.

16. The system of claim 9, wherein the method comprises:
determining a user type associated with the user interface; and
generating the content component using a generative model by providing to the generative model a base content component and an initial content type defined by the user type.

17. A method of training a machine learning model, comprising:
receiving a corpus of text;
generating a plurality of labeled text components from the corpus of text, the plurality of labeled text components including a label for a content type of a content class;
generating training data using the labeled text component by recording an interest level and a read speed attribute for the labeled text component; and
training a machine learning model, through a supervised learning process using the training data to output a present interest level for a present text component based on a present read speed attribute.

18. The method of claim 17, wherein the read speed attribute comprises a selection from a read speed; a read speed delta; a scroll rate, or a scroll position.

19. The method of claim 17, further comprising processing the training data to remove outliers or to clean noise.

20. The method of claim 17, wherein the present text component and the corpus of text use a common format.
